(19) United States
(12) Patent Application Publication
(10) Pub. No.: US 2026/0080890 A1
(43) Pub. Date: Mar. 19, 2026

(54) SYSTEM AND METHOD FOR EVALUATION OF AN AUDIO SIGNAL PROCESSING ALGORITHM

(71) Applicant: Dolby Laboratories Licensing Corporation, San Francisco, CA (US)

(72) Inventors: Yifei Liu, Beijing (CN); Kai Li, Beijing (CN); Yanmeng Guo, Beijing (CN)

(73) Assignee: Dolby Laboratories Licensing Corporation, San Francisco, CA (US)

(21) Appl. No.: 19/106,348

(22) PCT Filed: Aug. 23, 2023
(86) PCT No.: PCT/US2023/030922

§ 371 Date: Feb. 25, 2025

(30) Foreign Application Priority Data
Aug. 26, 2022 (WO) PCT/CN2022/115121
Sep. 20, 2022 (EP) 22196658.3

(51) Int. Cl. G10L 25/60; G10L 25/18

(52) U.S. Cl. CPC G10L 25/60; G10L 25/18

(57) ABSTRACT

The present disclose related to a system (1) and method for evaluating the performance of an audio processing scheme. The system (1) comprises an acoustic feature extractor (10A, 10B), configured to receive a plurality of segment pairs, each segment pair comprising a segment (101) and a processed segment (201). The acoustic feature extractor (10A, 10B) determines an acoustic feature associated with each segment and the system (1) further comprises an event detector (11), configured to receive the at least one acoustic feature of each segment (101, 201) and determine, for each segment pair and acoustic feature, if a difference between the acoustic feature of the segment and processed segment exceeds an event threshold. The system also comprises an event analyzer (12), configured to determine a performance metric based on each segment pair associated with a difference exceeding the event threshold.

### CROSS-REFERENCE TO RELATED APPLICATIONS

This application claims the benefit of priority from PCT Application No. PCT/CN2022/115121 filed Aug. 26, 2022 and European Patent Application No. 22196658.3 filed Sep. 20, 2022, each of which is incorporated by reference herein in its entirety.

### TECHNICAL FIELD OF THE INVENTION

The present disclosure relates to a system and method for evaluating the performance of an audio processing scheme, specifically an audio processing scheme for non-speech audio content.

### BACKGROUND OF THE INVENTION

In the field of audio processing it is in many applications desirable to identify and suppress an unwanted audio signal component present in an audio signal mixture, the audio signal mixture comprising a desirable audio signal component in addition to the unwanted audio signal component. For example, the unwanted audio signal component is noise while the desirable audio signal component is speech or music content.

Most audio signals, even when recorded in a professional studio with sophisticated recording equipment, will include some type of noise, such as white noise or pink noise which often is undesirable as it may impede the perceived quality of music, decrease the intelligibility of speech etc.

To this end, different algorithms have been proposed to identify the presence of noise in audio signals and suppress the noise. For instance, an audio engineer may manually design a suitable filter which suppresses the noise in a certain audio signal mixture while leaving other audio components unaffected. Additionally, there exists automatic algorithms which isolates and analyzes the noise present in an audio signal mixture and then establishes an appropriate filter or audio processing task to perform in order to suppress or remove the unwanted noise.

More recently, trainable models (employing e.g. neural networks) have been proposed for the identification and removal of noise present in audio signals. In some such cases a model is trained to receive a time-frequency representation of an audio signal and predict a time-frequency mask for suppressing any noise which is present, wherein the time-frequency mask indicates an attenuation or gain for each time and frequency bin.

Thus, there is today a large selection of different strategies which may be employed to reduce the noise of an audio signal. Depending on the circumstances, audio engineers may rely wholly on a manual or automatic algorithm-based processing of the audio signal to suppress noise or even combine manual processing, automatic algorithm-based processing, and processing with trained models to achieve the best results in terms of noise suppression.

In the same way, trained models or audio processing algorithms are used for other purposes other than noise suppression. For example, there exists trained models and audio processing algorithms for performing equalization, upmixing, downmixing or speech intelligibility enhancement.

### GENERAL DISCLOSURE OF THE INVENTION

However, the large selection of e.g. different types of noise suppression techniques makes it cumbersome to find an optimal method of noise suppression and, at the same time, for each type of noise suppression there is typically a trade-off between suppressing more noise and keeping the desired audio signal components (such as speech or music) free from distortions caused by the noise suppression. As most acoustic distortions are difficult to quantify it is difficult to compare the actual performance of different types of noise suppression methods which offer similar performance in terms of noise suppression ratio. The same applies to audio processing schemes of different types that performs other types of processing than noise suppression as there exists many different alternative algorithms and trained models for performing e.g. upmixing, downmixing or equalization.

Accordingly, the process of finding an appropriate audio processing scheme or trained model for performing a specific audio processing task often becomes a lengthy process of trial and error with subjective assessment of perceived quality.

It is therefore a purpose of the present disclosure to provide a system and method for accurate evaluation of audio processing schemes, such as a noise suppression scheme.

According to a first aspect of the present invention there is provided a system for evaluating the performance of an audio processing scheme. The system comprises an acoustic feature extractor, configured to receive a plurality of segment pairs, each segment pair comprising a segment and a processed segment, representing a portion of an audio signal and a corresponding portion of the audio signal processed with the audio processing scheme respectively. The acoustic feature extractor is further configured to, for each segment and processed segment, determine at least one acoustic feature associated with the segment. The system further comprises an event detector, configured to receive the at least one acoustic feature of each segment and processed segment and determine, for each segment pair and acoustic feature, if a difference between the acoustic feature of the segment and processed segment exceeds an event threshold. The system also comprises an event analyzer, configured to determine a performance metric based on each segment pair associated with a difference exceeding the event threshold.

A segment represents a portion of an audio signal, and a processed segment represents a portion of a processed audio signal. The processed audio signal is obtained by processing the (unprocessed) audio signal with the audio processing scheme and therefore these audio signal will represent the same audio content (e.g. recorded music) with the only difference being that the processed audio signal has undergone some type of audio processing (e.g. equalization or noise reduction).

With a segment pair it is meant two segments, one segment of the (unprocessed) audio signal, a segment, and one segment of the processed audio signal, a processed segment, wherein the segments of a segment pair represent portions of the unprocessed and processed audio signal which are corresponding (i.e. describing the same time portion of each audio signal).

With a difference it is meant any difference measure which can be defined between two instances of an acoustic feature. The difference measure may be described with a single scalar or multiple scalars. For instance, the acoustic feature is the loudness of the segment wherein the loudness is represented with a single scalar (representing the loudness). In this example, the difference measure is the difference in loudness obtained by subtracting the loudness scalar of one of the processed and unprocessed segment with the other one of the processed and unprocessed segment. As another example, the acoustic feature is the power spectra of the segment which is represented with a plurality of power spectral scalars that indicate the signal power at predetermined frequencies or within predetermined frequency bands. The difference measure may then be the difference in power at each frequency or frequency band obtained by subtracting the power spectral scalars of one of the processed and unprocessed segment with the other one of the processed and unprocessed segment. If the difference measure is represented with multiple scalars the event threshold may different or the same for each scalar, or a single threshold may be defined for a mean of the scalars.

With a performance metric it is meant a metric which at least collects information about the segment pairs associated with a difference exceeding the event threshold. The performance metric may indicate the number of segment pairs having a difference exceeding the event threshold and/or information allowing the segment pairs to be identified. The performance metric may indicate a mean or median of the difference measure for each segment having a difference exceeding the event threshold. Accordingly, the performance metric condenses the performance of an audio processing scheme into a select few measures, such as one or two measure. In one exemplary embodiment the performance metric indicates the event frequency (i.e. the ratio of the processed segment pairs having a difference exceeding the event threshold) and the difference which deviates the most from a mean difference of all segment pairs. As the performance metric comprises a select few measures it is easy to deduce the performance of an audio processing scheme based on the performance metric. Furthermore, when comparing multiple audio processing schemes the comparison is made more efficient by comparing the measures of the performance metric determined for each audio processing scheme.

The first aspect of the present invention is at least partially based on the understanding that by extracting at least one acoustic feature of the processed and unprocessed audio signal and comparing the acoustic features, segment-by-segment, an accurate measure of the performance of the audio processing scheme is obtained. Especially, by determining a performance metric based on the acoustic feature differences which exceed an event threshold the performance metric will indicate the performance of the audio processing scheme for the segment pair where the acoustic feature difference is largest and where the effects of the audio processing is the most noticeable.

In some implementations, the event analyzer is configured to determine a number of segment pairs associated with an acoustic feature difference exceeding the event threshold and the performance metric is based on the number of segment pairs associated with an acoustic feature difference exceeding the event threshold.

The number of segment pairs associated with an acoustic feature difference which exceeds the event threshold will indicate how often the audio processing scheme introduces a substantial change to the audio signal. In some implementations, the number of segment pairs associated with an acoustic feature difference which exceeds the event threshold is put in relation to the total number of segment pairs passed through the system, giving an event frequency metric. The event frequency metric may e.g. be given by a value between 0% and 100% wherein 0% indicates that no segment pairs are associated with a difference exceeding the event threshold and 100% indicates that all segment pairs exceeded the event threshold.

In some implementations, the event analyzer is configured to determine a mean difference of said plurality of segment pairs and determine the segment pair associated with a difference which deviates the most from the mean difference, and wherein said event analyzer is further configured to determine a performance metric based on the difference which deviates the most from the mean difference.

Accordingly as an addition or alternative to the number of acoustic feature difference events, a maximum segment pair difference may be determined and used to determine the performance metric. The maximum segment pair difference is the segment pair difference which deviates the most from the mean difference. That is, if the maximum segment pair difference is small the audio processing scheme performance is good in comparison to if the maximum segment pair difference is large.

In some implementations, the performance metric indicates both the number of segment pairs associated with an acoustic feature difference exceeding the event threshold and the maximum segment pair difference. Accordingly, the performance metric indicates how consistent the audio processing scheme performs across the segments (as indicated by the maximum segment pair difference) and how many segments that are affected by the audio processing scheme to a noticeable degree (as indicated by the number of segment pairs associated with an acoustic feature difference exceeding the event threshold).

According to a second aspect of the invention there is provided a method for evaluating the performance of an audio processing scheme. The method comprising the steps of receiving a plurality of segment pairs, each segment pair comprising a segment, representing a portion of an audio signal, and a processed segment, representing a corresponding portion of the audio signal processed with the audio processing scheme and determining at least one acoustic feature associated with each segment and processed segment. The method further comprises determining, for each segment pair and acoustic feature, if a difference between the acoustic feature of the segment and processed segment exceeds an event threshold and determining a performance metric based on each segment pair associated with a difference exceeding the event threshold. Optionally, the determined performance metric is provided to a downstream device for presentation, storage and/or processing. The downstream device may comprise at least one of a display device, an audio device, a processor, and a non-transitory storage medium.

According to a third aspect of the invention there is provided a non-transitory computer-readable medium storing instructions that, upon execution by one or more processors, cause the one or more processor to perform the method of the second aspect.

### BRIEF DESCRIPTION OF THE DRAWINGS

Aspects of the present invention will be described in more detail with reference to the appended drawings, showing currently preferred embodiments.

FIG. 1 illustrates a block diagram of a system for audio processing evaluation according to some implementations.

FIG. 2A depicts schematically an audio signal and a processed version of the audio signal, the unprocessed and processed audio signal being divided into a plurality of corresponding segments, according to some implementations.

FIG. 2B illustrates a block diagram illustrating two loudness extractors which extract a loudness feature from an unprocessed and processed segment, according to some implementations.

FIG. 3 illustrates a block diagram of a system for audio processing evaluation with an audio processor, according to some implementations.

FIG. 4 illustrates a block diagram of a system for audio processing evaluation with an audio processor and a non-speech separator according to some implementations.

FIG. 5 is a flowchart describing a method according to some implementations.

FIG. 6 illustrates a block diagram of a system for audio processing evaluation wherein different audio processors are evaluated and compared, according to some implementations.

### DETAILED DESCRIPTION OF CURRENTLY PREFERRED EMBODIMENTS

Systems and methods disclosed in the present application may be implemented as software, firmware, hardware or a combination thereof. In a hardware implementation, the division of tasks does not necessarily correspond to the division into physical units; to the contrary, one physical component may have multiple functionalities, and one task may be carried out by several physical components in cooperation.

The computer hardware may for example be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions (sequential or otherwise) that specify actions to be taken by that computer hardware. Further, the present disclosure shall relate to any collection of computer hardware that individually or jointly execute instructions to perform any one or more of the concepts discussed herein.

Certain or all components may be implemented by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system (i.e. a computer hardware) that includes one or more processors. Each processor may include one or more of a CPU, a graphics processing unit, and a programmable DSP unit. The processing system further may include a memory subsystem including a hard drive, SSD, RAM and/or ROM. A bus subsystem may be included for communicating between the components. The software may reside in the memory subsystem and/or within the processor during execution thereof by the computer system.

The one or more processors may operate as a standalone device or may be connected, e.g., networked to other processor(s). Such a network may be built on various different network protocols, and may be the Internet, a Wide Area Network (WAN), a Local Area Network (LAN), or any combination thereof.

The software may be distributed on computer readable media, which may comprise computer storage media (or non-transitory media) and communication media (or transitory media). As is well known to a person skilled in the art, the term computer storage media includes both volatile and non-volatile, removable and non-removable media implemented in any method or technology for storage of information such as computer readable instructions, data structures, program modules or other data. Computer storage media includes, but is not limited to, physical (non-transitory) storage media in various forms, such as EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Further, it is well known to the skilled person that communication media (transitory) typically embodies computer readable instructions, data structures, program modules or other data in a modulated data signal such as a carrier wave or other transport mechanism and includes any information delivery media.

FIG. 1 depicts schematically a system 1 for evaluating the performance of an audio processing scheme. The system 1 comprises two feature extractors 10A, 10B, wherein the first feature extractor 10A receives a segment of the audio signal and the second feature extractor 10B receives a processed segment of the processed audio signal. The audio signal and the processed audio signal, and the segments thereof, are corresponding and may e.g. represent the same audio content with the processed audio signal having been processed with an audio processing scheme.

The audio signal, and processed audio signal, may represent a single or multi-channel audio presentation. That is, the processed and unprocessed audio signal may be a mono audio signal or a multi-channel audio signal, e.g. representing a stereo, binaural or surround audio presentation with two or more channels.

The audio processing scheme may be any audio processing scheme or audio processing algorithm. The audio processing scheme may e.g. be implemented by a trained model. In some implementations, the audio processing scheme is a noise suppression processing scheme configured to reduce the noise present in an audio signal. The noise suppression process may e.g. utilize a neural network trained to obtain an audio signal segment and output a processed audio signal with reduced noise.

The audio processing scheme may alternatively involve one or more other types of audio processing, such as adding or removing reverberation, equalization (EQ), speech and/or music separation, speech intelligibility enhancement, filtering, upmixing and downmixing.

Additionally or alternatively, the audio processing scheme of the audio processor 13 involves encoding and decoding the audio signal, wherein the decoded audio signal is the processed audio signal. Ideally, an encoding/decoding process is lossless wherein the decoded audio signal is equivalent with the audio signal which was originally used for encoding. However, in most encoding/decoding processes (e.g. when there is a bitrate constraint for the encoded representation), the decoded audio signal will be different from the original audio signal which was used as input to the encoder. Various encoding/decoding processes may therefore be compared by e.g. comparing the resulting performance metric obtained for each encoding/decoding process with the system 1 of FIG. 1. Additionally, the audio processor 13 may simulate a packet loss, which means that some of the encoded data is omitted, whereby the processed audio signal has been degraded by both codec loss (associated with the encoding and decoding process) and packet loss (associated with data transmission).

Accordingly, in some examples the audio processing scheme is an upmixing process which obtains an audio signal representing an audio presentation comprising a first number of channels and performs upmixing to obtain an audio presentation with a second number of channels, the second number of channels being greater than the first number of channels. For example, the audio processing scheme is configured to obtain a 2.0 (stereo or binaural) audio presentation and perform upmixing to obtain a surround presentation, such as a 5.1, 7.1 or 7.1.4 presentation.

Alternatively, the audio processing scheme may be a downmixing process which obtains an audio signal representing an audio presentation comprising a first number of channels and performs downmixing to obtain an audio presentation with a second number of channels, the first number of channels being greater than the second number of channels. For example, the audio processing scheme is configured to obtain a surround presentation (such as a 5.1, 7.1 or 7.1.4 presentation) and perform downmixing to obtain a 2.0 presentation (such as a stereo or binaural presentation).

Each acoustic feature extractor 10A, 10B is configured to extract at least one acoustic feature of the segment and processed segment respectively. The at least one acoustic feature may be at least one of: a loudness, a speech intelligibility metric (e.g. a short term objective intelligibility, STOI) and a frequency spectrum (power spectrum) property. The STOI may be calculated for each segment and will be a value between zero and one, wherein zero indicates worst intelligibility and one indicates best intelligibility.

The loudness of each segment may e.g. be loudness as defined in the ITU-R BS.1770-4 standard titled Algorithms to Measure Audio Programme Loudness and True-Peak Audio Level.

A frequency spectrum property may e.g. be a shape of spectral envelope of each segment, a maximum spectral level or power in one or more predetermined spectral band, a ratio between the spectral level or power between two different spectral bands or the power spectral balance. For example, the event threshold may set a threshold for how large of a shift in the power weighted center point is tolerable before the segment pair is labelled as an acoustic feature difference event.

By comparing the features of the segment and processed segment an acoustic feature difference is extracted. An event detector 11 is configured to obtain the acoustic feature of the segment and processed segment, calculate the difference between the acoustic features, and determine whether or not the difference exceeds a predetermined event threshold. If the difference between the acoustic feature of the segment and processed segment exceeds the event threshold, the event detector 11 determines that the corresponding segment pair is associated with a difference event.

The event threshold may be a predetermined value. For instance, the event threshold may specify a ratio between the loudness or STOI of the processed and unprocessed segment wherein a segment pair with a ratio exceeding the event threshold will be classified as a loudness or STOI difference event.

In some implementations, the event threshold is determined based on the distribution of the acoustic feature difference of each segment pair. For example, the event threshold is a predetermined number of standard deviations (e.g. two standard deviations) from the mean acoustic feature difference. That is, in some implementations the mean acoustic feature difference and standard deviation of the acoustic feature differences is determined based on the acoustic feature of each processed and unprocessed segment and the event threshold is based on the distribution of the acoustic feature differences.

The number of difference events detected by the event detector 11, or the magnitude of the detected difference events, is provided to an event analyzer 12 as event information, wherein the event analyzer 12 is configured to determine a performance metric based on the event information. The performance metric may e.g. indicate the number of difference events, the difference event frequency, the maximum difference, mean difference or median difference.

Alternatively or additionally, the size of the standard deviation of the acoustic feature difference for all segment pairs and/or all segment pairs associated with an acoustic feature event is used to extract the performance metric. For example, the performance metric indicates the standard deviation of the acoustic feature difference for all segment pairs and/or all segment pairs associated with an acoustic feature event which is an indicator of how consistent the audio processing scheme performs.

It is understood that in some cases (e.g. when the audio processing involves upmixing or downmixing as described in the above) the audio signal and processed audio signal may comprise a plurality of audio channels. For instance, a 2.0 audio presentation comprises two channels and a 5.1 presentation comprises six channels. In these cases each acoustic feature extractor 10A, 10B is configured to extract the same number of acoustic features and corresponding acoustic features to allow the difference between the at least one acoustic feature of each segment to be determined.

Consider for example the case when the audio processing scheme performs downmixing from a 5.1 presentation to a 2.0 binaural presentation. The (unprocessed) 5.1 presentation is provided to the first feature extractor 10A which determines a combined acoustic feature (e.g. a loudness) across all six channels and the processed 2.0 presentation is provided to the to the second feature extractor 10B which determines a corresponding combined acoustic feature (e.g. a loudness) across the two channels which can be compared to the acoustic feature of the first feature extractor 10A.

A single combined acoustic feature is only one example of many in which audio signals representing audio presentations with different number of channels can be compared. For example, the first feature extractor 10A in the above example may alternative determine a left acoustic feature based on at least the two left 5.1 channels together with the center channel and Low Frequency Effects (LFE) channel and a right acoustic feature based on the two right 5.1 channels together with the center channel and LFE channel. Similarly, the second acoustic feature extractor 10B may then be configured to determine a left acoustic feature based on the left channel of the 2.0 presentation and a right acoustic feature based on the right channel of the 2.0 presentation. The event detector 11 may then compare the left and right acoustic feature separately and determine a left and right acoustic feature difference.

In some implementations, the performance metric indicates the number of difference events for the plurality of audio signal pairs input to the feature extractors 10A, 10B. For example, the performance metric indicates an event difference frequency indicating the ratio of the plurality of segment pairs which are associated with a difference event.

Additionally or alternatively, the performance metric indicates a maximum segment pair difference. The maximum segment pair difference is extracted by the event analyzer 12 by determining the mean acoustic feature difference of each segment pair and determining the acoustic feature difference which differs most from the mean acoustic feature difference.

As an illustrative example it is considered that the at least one acoustic feature is the loudness of each segment and processed segment. In this example, the feature extractors 10A, 10B determines that for eight (unprocessed) segments the loudness of each segment is −20 dB, −30 dB, −30 dB, −40 dB, −50 dB, −60 dB, −80 dB, −100 dB and for the corresponding eight processed segments the loudness of each processed segment is −40 dB, −60 dB, −70 dB, −90 dB, −110 dB, −130 dB, −160 dB, −190 dB.

The event detector compares the segment and processed segment of each segment pair and finds that the acoustic feature difference of each segment pair is 20 dB, 30 dB, 40 dB, 50 dB, 60 dB, 70 dB, 80 dB, 90 dB respectively which gives a mean acoustic feature difference of 55 dB. The maximum segment pair difference is given by the segment pair associated with an acoustic feature difference which deviates the most from the 55 dB mean difference, and in this example the first and last segment pair (associated with an acoustic feature difference of 20 dB and 90 dB respectively) both deviate with the same amount from the mean acoustic feature difference, namely 35 dB, meaning that the maximum segment pair difference is 35 dB.

The event analyzer 12 obtains event information comprising at least one of the number of detected difference events, the difference event frequency and the maximum segment pair difference and determines a performance metric based on at least one of the number of detected difference events, the difference event frequency and the maximum segment pair difference. The performance metric may e.g. be a direct indication of the event information and may serve to evaluate the performance of one or more audio processing schemes. In embodiments wherein the processed audio signal and (unprocessed) audio signal represents audio presentations with multiple audio channels the event information (and the performance metric) may comprise multiple event information instances and performance metric instance (e.g. one for each channel or one for right channels and one for left channels as exemplified in the above) or a single instance representing for e.g. an average across the channels or maximum difference across the channels.

It is also envisaged that the system 1 of FIG. 1 may be implemented with a single feature extractor 10A, 10B configured to process the audio signal and processed audio signal in parallel or sequentially. That is, a single feature extractor 10A, 10B could e.g. first extract the at least one feature of each segment of the audio signal and then extract the at least one feature of each processed segment of the processed audio signal whereby the difference is determined after the acoustic feature of all segments of the processed audio signal and audio signal have been determined. Alternatively, a single feature extractor 10A, 10B may be configured to alternate between processing a number of segments and the same number of processed segments, whereby the difference is determined for the number of segments at a time.

In some implementations, the system 1 further comprises a downstream device (not shown) configured to receive the determined performance metric and present, store or process the performance metric. The downstream device may comprise at least one of a display device, an audio device, a processor, and a non-transitory storage device. Accordingly, the downstream device may store the performance metric and e.g. compare the performance metric with at least one other, previously determined, performance metric. For example, the downstream processing device may determine if the performance metric indicates a higher or lower event frequency compared to the at least one other, previously determined, performance metric. Additionally or alternatively, the downstream device presents the performance metric visually, using the display device, and/or acoustically, using the audio device, to a human operator of the system 1.

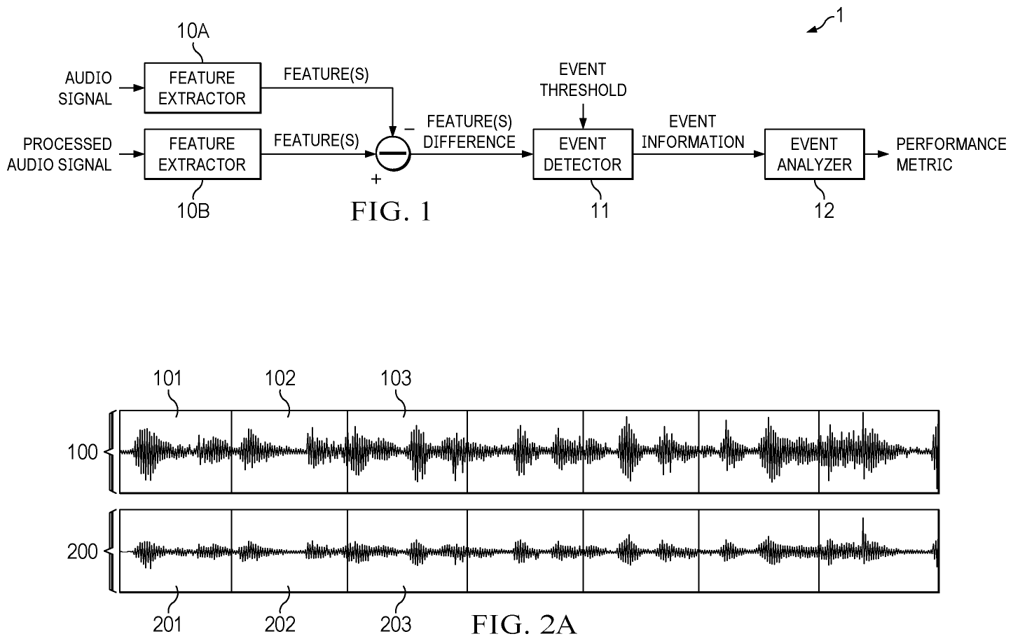

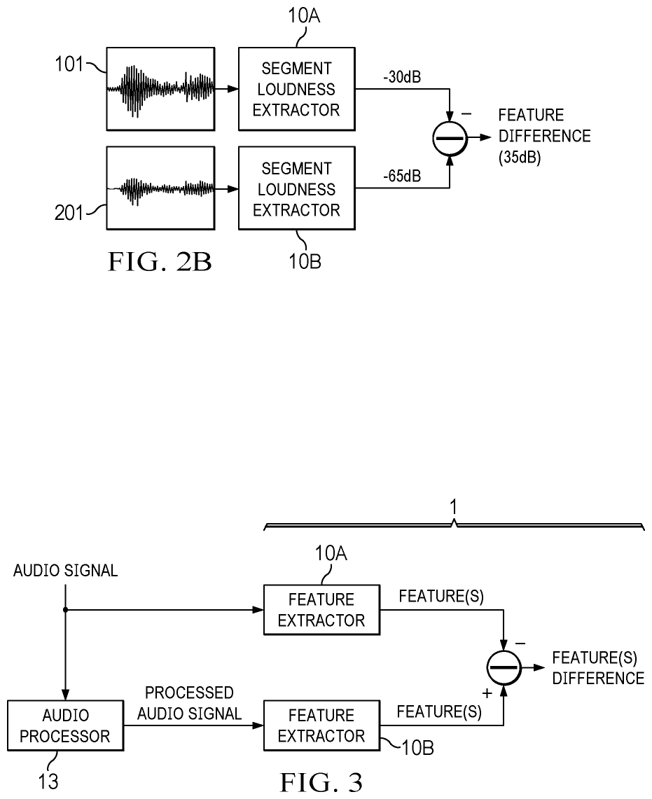

FIG. 2A illustrates two audio signals schematically, an (unprocessed) audio signal 100 and a processed audio signal 200. The audio signal 100 is divided into a plurality of consecutive segments 101, 102, 103 and the processed audio signal 200 is divided into a corresponding plurality of consecutive segments 201, 202, 203. The segments may be non-overlapping or (although not depicted in FIG. 2A) the segments 101, 102, 103, 201, 202, 203 of each audio signal may be partially overlapping. The segments 101, 102, 103, 201, 202, 203 may represent different duration(s) of the respective audio signal 100, 200 or, preferably, each segment 101, 102, 103, 201, 202, 203 represent a predetermined duration of the respective audio signal 100, 200.

In some implementations, each segment represents 100 milliseconds of the respective audio signal 100, 200 although it is envisaged that the segments may represent any duration. For example, each segment represents between 10 and 400 milliseconds, preferably between 10 and 200 milliseconds and most preferably between 10 and 100 milliseconds.

In some implementations, the segments 101, 102, 103, 201, 202, 203 have between 20% and 80% overlap, preferably between 60% and 40% overlap, most preferably about 50% overlap. However, it is envisaged that the segments 101, 102, 103, 201, 202, 203 may have no overlap.

As the segmentation of the audio signal 100 and processed audio signal 200 are corresponding the audio signal 100 and processed audio signal 200 together form a plurality of segment pairs, each segment pair comprising a segment 101 of the audio signal 100 and a corresponding processed segment 201 of the processed audio signal 200. In the example depicted in FIG. 2A the first segment 101 forms a segment pair with the first processed segment 201, the second segment 102 forms a segment pair with the second processed segment 202 and so on.

With further reference to FIG. 2B an exemplary implementation of the audio processing evaluation system is provided wherein the first segment pair 101, 201 is provided to an individual acoustic feature extractor 10A, 10B. In the embodiment of FIG. 2B the acoustic feature is the loudness of the segment, and the acoustic feature extractors 10A, 10B are loudness extractors configured to determine the loudness of each segment.

As seen in FIG. 2B, feature extractor 10A determines that the loudness of the segment 101 is −30 dB whereas feature extractor 10B determines that the loudness of the processed segment is lower, namely −65 dB. Accordingly, a loudness difference associated with the segment pair 101, 201 is identified and the difference is −30−(−65)=35 dB.

FIG. 3 depicts another embodiment of the system 1 for evaluating an audio processing scheme. In this embodiment, an audio processor 13 configured to process audio with the audio processing scheme is included as an addition to the system 1. In FIG. 1, the processed audio signal has been processed with the audio processing scheme externally, e.g. beforehand, before being provided to the system 1. As seen in FIG. 3 it is envisaged that the audio processor 13 which performs the audio processing scheme may be provided directly in connection to the evaluation system 1. In such embodiments, the segments of the audio signal are provided to the system 1 and input to the first feature extractor 10A which extracts at least one acoustic feature from each segment. The segments of the audio signal are also provided to the audio processor 13 which processes the audio signal with the audio processing scheme so as to obtain corresponding processed audio signal segments. The processed audio signal segments are provided to the second feature extractor 10B which extracts at least one acoustic feature from each processed audio signal segment.

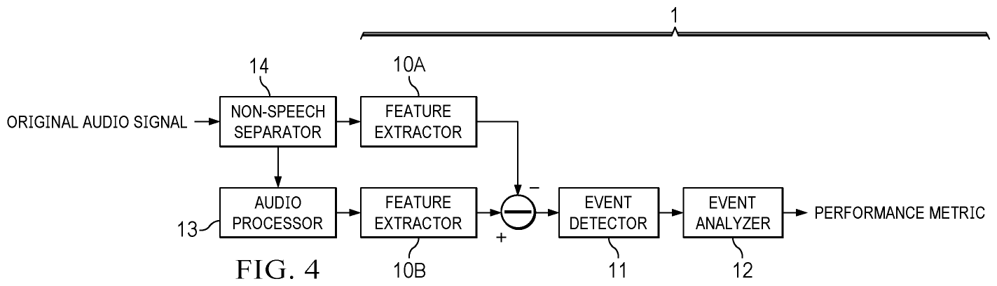

FIG. 4 depicts yet another embodiment of the system 1 for evaluating an audio processing scheme. In comparison to the embodiment depicted in FIG. 3, the embodiment in FIG. 4 also comprises a non-speech separator unit 14 connected to the system 1. The non-speech separator unit 14 is configured to obtain an original audio signal comprising a mix of speech audio content and non-speech audio content and extract the non-speech audio content.

In some implementations, the non-speech separator unit 14 comprises a neural network trained to predict the non-speech content of an audio segment given an input audio signal segment comprising a mixture of speech and non-speech audio content. For example, the non-speech separator unit 14 may configured to operate on a time-frequency tile representation of the original audio signal segment and predict a mask which, when applied to the original audio signal segment, attenuates the speech content leaving mainly (or only) the non-speech content.

It is understood that the setup of FIG. 4 allows audio processing schemes to be evaluated for non-speech performance despite the audio signals containing any type of audio content. The evaluation system 1 is especially suited for non-speech audio content for which it is difficult to quantize the effects of different audio processing schemes. For speech content, it is crucial that the audio processing does not impede the speech intelligibility, however for non-speech audio signals, such as music or recorded sounds from nature, it difficult to specify which are the desired properties of the audio content that should not be impeded. To this end, the evaluation system 1 is capable of extracting a performance metric in a repeatable and accurate manner for any type of audio processor 13, even for non-speech content.

For example, if the audio processing scheme is noise suppression a processed and unprocessed audio signal may be presented to a human evaluator to compare the two audio signals. If the audio signal comprises speech, it is possible for the human evaluator to determine, and e.g. put a score, on the speech intelligibility of the processed and unprocessed audio signal to evaluate the performance of the noise suppression algorithm. If however the audio signal comprises non-speech content it is difficult for a human evaluator to pinpoint and assess differences between the processed and unprocessed audio signal. However, with the evaluation system 1 as described herein it becomes possible to accurately and fairly evaluate audio processing scheme performance for non-speech audio signals.

It is also envisaged that while FIG. 4 illustrates the event detector 11 receiving an acoustic feature difference as a single input, it is envisaged that the event detector 11 can be configured to receive the acoustic features of the feature extractor(s) 10A, 10B directly and calculate the acoustic feature difference prior to comparing it to the event threshold.

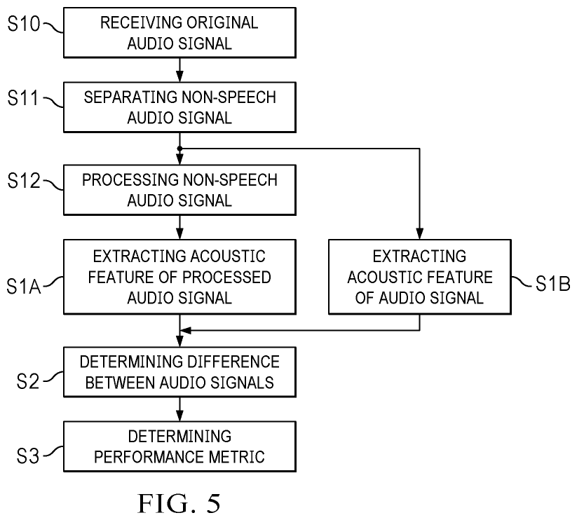

With further reference to FIG. 5 the operation of the non-speech separator 14, the audio processor 13 and the evaluation system 1 from FIG. 4 will now be described in more detail. At step S10 the original audio signal is received by the non-speech separator 14 unit which isolates the non-speech content and outputs a non-speech content audio signal at step S11.

The non-speech audio signal segments are provided to the first feature extractor 10A which extracts at least one acoustic feature of the unprocessed segments at S1B. Also, the non-speech audio signal segments are provided to the audio processor 13, which processes the non-speech audio signal segments at S12 with the audio processing scheme so as to obtain processed non-speech audio signal segments. The processed non-speech audio signal segments are provided to the second feature extractor 10B which extracts the at least one acoustic feature of the processed segments at S1A.

At step S2 the event detector 11 determines a difference between the at least one acoustic feature of each segment pair. In some implementations, the event detector 11 compares the difference between the acoustic feature(s) to an event threshold and indicates which segment pairs are associated with an acoustic feature difference which exceeds the event threshold as event information. The event information is provided to the event analyzer which determines a performance metric at S3 based on the event information and the segment pairs associated with an acoustic feature difference exceeding the event threshold.

In some implementations, the performance metric is provided to a downstream device for at least one of presentation, processing and/or storage. For instance, the downstream device may comprise a display which displays the performance metric. Alternatively or additionally, the downstream device stores the performance metric for later presentation or processing. The downstream device may process the performance metric and e.g. compare the performance metric to a threshold or to another, previously determined, performance metric associated with a different audio processing scheme.

In some implementations, the audio processing evaluation system 1 is used with an audio signal and at least two processed versions of the audio signal, comprising a first processed audio signal (i.e. the audio signal processed with a first audio processing scheme) and a second processed audio signal (i.e. the audio signal processed with a second audio processing scheme). First, the audio signal and the first processed audio signal is provided to the system 1 so as to extract a first performance metric. Subsequently, the audio signal and the second processed audio signal is provided to the system 1 to obtain a second performance metric. By comparing the first and second performance metrics an accurate and repeatable performance measurement of the first and second audio processing schemes is provided.

For example, if the first and second audio processing schemes are different noise suppression schemes, and the acoustic feature is the segment loudness it may be established which out of the two audio processing schemes performs most consistent in terms of having the fewest loudness difference events. For example, if the first audio processing scheme is associated with a performance metric indicating a lower difference event frequency it may be determined that the first audio processing scheme has a more consistent performance which may be desirable.

Thus, in this manner any two or more audio processing schemes may be efficiently and accurately evaluated, and based on the performance metric of each audio processing scheme, the audio processing schemes can be compared in a simple and objective manner.

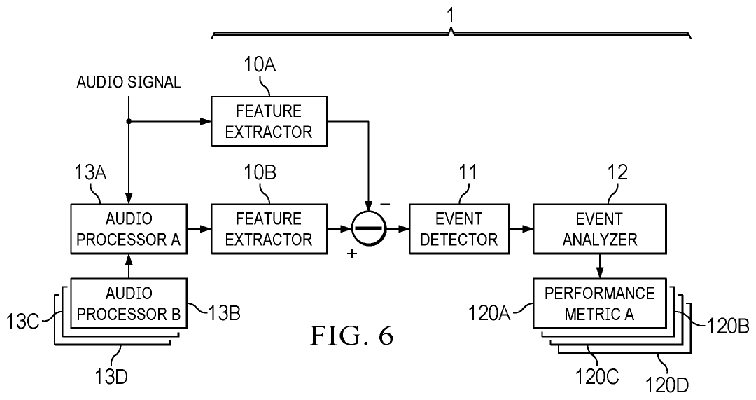

The process of evaluating at least two audio processing schemes will now be described in more detail. FIG. 6 illustrates an evaluation system 1 communicating with an audio the audio processor 13A implementing an audio processing scheme. The audio processor 13A is replaced with at least one different audio processing scheme or audio processor 13B, 13C, 13D. Accordingly, the same audio signal may be processed by at least two audio processing schemes, providing at least two processed audio signals. For each processed audio signal the at least one acoustic feature is extracted for each processed segment and compared to the at least one acoustic feature of the corresponding unprocessed segment so as to determine an acoustic feature difference. A performance metric 120A, 120B, 120C, 120D is then determined based on the acoustic feature difference in accordance with the embodiments described in the above.

In this way a performance metric 120A, 120B, 120C, 120D is obtained for each of said at least two evaluated audio processing schemes or audio processors 13A, 13B, 13C, 13D. The performance metrics 120A, 120B, 120C, 120D of each evaluated audio processing scheme or audio processor 13A, 13B, 13C, 13D may be provided to the downstream device for presentation, storage, or processing. For example, as seen in FIG. 6 a first performance metric 120A is obtained associated with the first audio processing scheme or audio processor 13A and a second performance metric 120B is obtained associated with the second audio processing scheme or audio processor 13B, and so forth, for an optional third and fourth audio processing scheme or audio processor 13C, 13D. As the audio signal used to evaluate the at least two audio processing schemes or audio processors 13A, 13B, 13C, 13D is the same, the associated performance metrics 120A, 120B, 120C, 120D can be compared to determine how the at least two audio processing schemes or audio processors 13A, 13B, 13C, 13D performs compared to each other.

In some implementations, the downstream device has access to a database of previously determined performance metrics associated with a plurality of corresponding audio processing schemes, or has the database stored in its non-transitory storage medium. When a current performance metric for a current audio processing scheme is obtained, the downstream device may compare the current performance metric to the performance metrics of the database and present the performance of the current audio processing scheme in comparison to the audio processing schemes of the database by comparing the performance metric. The database may collect the performance metric associated with audio processing schemes of a same type (e.g. noise suppression) and the downstream processing device may have stored, or at least access to, a plurality of databases, each database associated with a different type of audio processing scheme (e.g. noise suppression, upmixing, downmixing, reverberation processing, encoding/decoding processing etc.). To this end, the downstream device may be configured to select a database, based on the type of audio processing scheme, and then present or store a comparison of the current performance metric with at least one other performance metric of the selected database.

Similarly, the downstream device may store, or have access to, different versions of the databases, each version being associated with a same (original) unprocessed audio signal. As the performance metric may vary depending on the unprocessed audio signal which is used, the downstream device ensure a fair comparison of the audio processing schemes by selecting a database and version of the database corresponding to the audio processing scheme and unprocessed audio signal used. Accordingly, while the downstream audio processing device may present, process or store the performance metric of single evaluated audio processing scheme at a time the downstream device also allows the performance of multiple (e.g. hundreds) of different audio processing schemes to be evaluated automatically for one or more (e.g. at least two) unprocessed audio signals. The result of the evaluation, e.g. a list of the performance metrics of the evaluated audio processing schemes, may then be stored or visually and/or acoustically presented to a human operator.

To illustrate this, an example is considered in which a first and second audio processor 13A, 13B are evaluated with an audio signal. The acoustic feature that is extracted by each acoustic feature extractor 10A, 10B is a spectral property of each segment, e.g. the spectral energy in a predetermined frequency band, and the event threshold implemented by the event detector is set at 3 dB. Accordingly, if there is a spectral energy difference between the processed and unprocessed segment in the predetermined frequency band exceeding 3 dB the segment pair will be associated with an acoustic feature difference event.

The resulting performance metric 120A for the first audio processor 13A may then indicate that X % of the segment pairs are associated with an acoustic feature difference event with maximum segment pair difference of A standard deviations. In the same way, the resulting performance metric 120B for the second audio processor 13B may then indicate that Y % of the segment pairs are associated with an acoustic feature difference event with a maximum segment pair difference of B standard deviations. By comparing, e.g. by the downstream device, X and A of the first audio processor 13A with Y and B of the second audio processor 13B the audio processor with the best performance may be established.

If a plurality of audio processing schemes or audio processors 13A, 13B, 13C, 13D are compared (e.g. by the downstream device), a corner case threshold may be used to eliminate the worst performing audio processors or audio processing schemes 13A, 13B, 13C, 13D directly. The corner case threshold may specify a maximum segment pair difference threshold, and if a performance metric indicates a maximum segment pair difference exceeding this threshold, the associated audio processing scheme or audio processor 13A, 13B, 13C, 13D is omitted. The corner case threshold may specify a maximum acoustic feature difference event frequency threshold, and if a performance metric indicates a feature difference event frequency exceeding this threshold, the associated audio processing scheme or audio processor 13A, 13B, 13C, 13D is omitted.

The maximum segment pair difference threshold could e.g. be set as 5 standard deviations and the maximum acoustic feature difference event frequency threshold could be set as 5% although other threshold levels are envisaged.

Unless specifically stated otherwise, as apparent from the following discussions, it is appreciated that throughout the disclosure discussions utilizing terms such as “processing”, “computing”, “calculating”, “determining”, “analyzing” or the like, refer to the action and/or processes of a computer hardware or computing system, or similar electronic computing devices, that manipulate and/or transform data represented as physical, such as electronic, quantities into other data similarly represented as physical quantities.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention. Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with instructions for carrying out such a method or element of a method forms a means for carrying out the method or element of a method. Note that when the method includes several elements, e.g., several steps, no ordering of such elements is implied, unless specifically stated. Furthermore, an element described herein of an apparatus embodiment is an example of a means for carrying out the function performed by the element for the purpose of carrying out the embodiments of the invention. In the description provided herein, numerous specific details are set forth. However, it is understood that embodiments of the invention may be practiced without these specific details. In other instances, well-known methods, structures and techniques have not been shown in detail in order not to obscure an understanding of this description.

The person skilled in the art realizes that the present invention by no means is limited to the embodiments described above. On the contrary, many modifications and variations are possible within the scope of the appended claims. For example, as an alternative to the event information indicating which (or the number of) segment pairs associated with an acoustic feature event the event information could be based on the maximum segment pair difference. In such embodiments it is not necessary for the event detector to compare the acoustic feature difference of each segment pair to the event threshold and the event detector instead determines the mean acoustic feature difference across all segment pairs and determines the acoustic difference which exceeds the most from the mean acoustic feature difference. That is, one or both of the maximum segment pair difference or which (or the number of) segment pairs that exceed the event threshold is determined by the event detector and the performance metric is thus based on one or both of the maximum segment pair difference or which (or the number of) segment pairs that exceed the event threshold.

Various aspects of the present invention may be appreciated from the following Enumerated Example Embodiments (EEEs):
EEE1. A system (1) for evaluating the performance of an audio processing scheme, comprising:
   an acoustic feature extractor (10A, 10B), configured to receive a plurality of segment pairs, each segment pair comprising a segment (101), representing a portion of an audio signal (100), and a processed segment (201), representing a corresponding portion of the audio signal processed with the audio processing scheme (200), and for each segment (101) and processed segment (201), determine an acoustic feature associated with the segment,
   an event detector (11), configured to receive the at least one acoustic feature of each segment (101) and processed segment (201) and determine, for each segment pair and acoustic feature, if a difference between the acoustic feature of the segment and processed segment exceeds an event threshold, and
   an event analyzer (12), configured to determine a performance metric based on each segment pair associated with a difference exceeding the event threshold.
EEE2. The system (1) according to EEE1, wherein the audio processing scheme is a noise suppression scheme.
EEE3. The system (1) according to EEE1 or EEE2, wherein the acoustic feature indicates at least one property of a frequency spectrum of the segment.
EEE4. The system (1) according to any of the preceding EEEs, wherein the acoustic feature indicates a loudness measure of the segment.
EEE5. The system (1) according to any of the preceding EEEs, wherein the event analyzer (11) is configured to determine a number of segment pairs associated with an acoustic feature difference exceeding the event threshold, and
   wherein the performance metric is based on the number of segment pairs associated with an acoustic feature difference exceeding the event threshold.
EEE6. The system (1) according to any of the preceding EEEs, wherein the event threshold is based on an average difference of said plurality of segment pairs.
EEE7. The system (1) according to any of the preceding EEEs,
   wherein said event analyzer (12) is configured to determine a mean difference of said plurality of segment pairs and determine the segment pair associated with a difference which deviates the most from the mean difference, and
   wherein said event analyzer (12) is further configured to determine a performance metric based on the difference which deviates the most from the mean difference.
EEE8. The system (1) according to any of the preceding EEEs, wherein the event threshold is a predetermined number of standard deviations of a difference distribution based on the difference of said plurality of segments.
EEE9. The system (1) according to any of the preceding EEEs, further comprising: an audio processor (13), configured to receive segments (101) of the audio signal (100), process the audio signal segments (101) with the audio processing scheme and output processed audio signal segments (201).
EEE10. The system (1) according to any of the preceding EEEs, further comprising:
   a non-speech separation module (14) configured to obtain segments of an original audio signal, the original audio signal comprising a mixture of non-speech content and speech content, and predict the segments (101) of the audio signal (100) with the speech content removed.
EEE11. The system (1) according to any of the preceding EEEs, wherein each segment (101, 201) has a duration of less than 400 milliseconds, preferably less than 200 milliseconds and most preferably about 100 milliseconds, with 50% overlap.
EEE12. A method for evaluating the performance of an audio processing scheme, comprising:
   receiving a plurality of segment pairs, each segment pair comprising a segment (101), representing a portion of an audio signal (100), and a processed segment (201), representing a corresponding portion of the audio signal processed with the audio processing scheme (200);
   determining (S1A, S1B) at least one acoustic feature associated with each segment (101) and processed segment (201);
   determining (S2), for each segment pair and acoustic feature, if a difference between the acoustic feature of the segment and processed segment exceeds an event threshold; and
   determining (S3) a performance metric based on each segment pair associated with a difference exceeding the event threshold.
EEE13. The method according to EEE12, further comprising: outputting the performance metric to a downstream device for presentation, processing, and/or storage.
EEE14. A non-transitory computer-readable medium storing instructions that, upon execution by one or more processors, cause the one or more processor to perform the method of EEE12 or EEE13.

1-19. (canceled)

20. A system for evaluating the performance of all types of audio processing schemes, including audio processing schemes for speech audio content, audio processing schemes for non-speech audio content and audio processing schemes for a mixture of speech and non-speech audio content, the system comprising:
an acoustic feature extractor, configured to receive a plurality of segment pairs, each segment pair comprising a segment, representing a portion of an audio signal, and a processed segment, representing a corresponding portion of the audio signal processed with a selected audio processing scheme, and for each segment and processed segment, determine at least one acoustic feature associated with the segment, wherein the acoustic feature extractor is configured to determine the at least one acoustic feature for segment pairs comprising any type of audio content,
an event detector, configured to receive the at least one acoustic feature of each segment and processed segment and determine, for each segment pair and acoustic feature, if a difference between the acoustic feature of the segment and processed segment exceeds an event threshold, and
an event analyzer, configured to determine a performance metric based on each segment pair associated with a difference exceeding the event threshold.

21. The system according to claim 20, wherein the audio processing scheme is a noise suppression scheme.

22. The system according to claim 20, wherein the acoustic feature indicates at least one property of a frequency spectrum of the segment.

23. The system according to claim 20, wherein the acoustic feature indicates a loudness measure of the segment.

24. The system according to claim 20, wherein the event analyzer is configured to determine a number of segment pairs associated with an acoustic feature difference exceeding the event threshold, and
wherein the performance metric is based on the number of segment pairs associated with an acoustic feature difference exceeding the event threshold.

25. The system according to claim 20, wherein the event threshold is based on an average difference of said plurality of segment pairs.

26. The system according to claim 20,
wherein said event analyzer is configured to determine a mean difference of said plurality of segment pairs and determine the segment pair associated with a difference which deviates the most from the mean difference, and
wherein said event analyzer is further configured to determine a performance metric based on the difference which deviates the most from the mean difference.

27. The system according to claim 20, wherein the event threshold is a predetermined number of standard deviations of a difference distribution based on the difference of said plurality of segments.

28. The system according to claim 20, further comprising:
an audio processor, configured to receive segments of the audio signal, process the audio signal segments with the selected audio processing scheme and output processed audio signal segments to the acoustic feature extractor.

29. The system according to claim 20, further comprising:
a non-speech separation module configured to obtain segments of an original audio signal, the original audio signal comprising a mixture of non-speech content and speech content, and predict the segments of the audio signal with the speech content removed.

30. The system according to claim 20, wherein each segment has a duration of less than 400 milliseconds, preferably less than 200 milliseconds and most preferably about 100 milliseconds, with 50% overlap.

31. The system according to claim 20, further comprising a downstream device configured to receive the determined performance metric and present, store or process the performance metric.

32. The system according to claim 31, wherein the downstream device is configured to compare the performance metric with at least one other previously determined performance metric associated with a different audio processing scheme.

33. The system according to claim 20, wherein the audio signal comprises non-speech audio content.

34. A method for evaluating the performance of all types of audio processing schemes, including audio processing schemes for speech audio content, audio processing schemes for non-speech audio content and audio processing schemes for a mixture of speech and non-speech audio content, the method comprising:
receiving a plurality of segment pairs, each segment pair comprising a segment, representing a portion of an audio signal, and a processed segment, representing a corresponding portion of the audio signal processed with a selected audio processing scheme;
determining, for each segment and processed segment, at least one acoustic feature associated with the segment, wherein the at least one acoustic feature is determined for segment pairs comprising any type of audio content;
determining, for each segment pair and acoustic feature, if a difference between the acoustic feature of the segment and processed segment exceeds an event threshold; and
determining a performance metric based on each segment pair associated with a difference exceeding the event threshold.

35. The method according to claim 34, further comprising:
outputting the performance metric to a downstream device for presentation, processing, and/or storage.

36. The method according to claim 35, further comprising comparing the performance metric with at least one other previously determined performance metric associated with a different audio processing scheme.

37. The method according to claim 34, wherein the audio signal comprises non-speech audio content.

38. A non-transitory computer-readable medium storing instructions that, upon execution by one or more processors, cause the one or more processor to perform the method of claim 34.
